(19) United States
(12) Patent Application Publication
(10) Pub. No.: US 2005/0275805 A1
(43) Pub. Date: Dec. 15, 2005

(54) Slideshow composition method

(76) Inventors: Yu-Ru Lin, Taoyuan (TW); Chun-Yi Wang, Taipei (TW)

Correspondence Address: BIRCH STEWART KOLASCH & BIRCH, PO BOX 747, FALLS CHURCH, VA, 22040-0747, US

(21) Appl. No.: 10/866,671

(22) Filed: Jun. 15, 2004

(51) Int. Cl. G03B 31/00

(52) U.S. Cl. 352/12

(57) ABSTRACT

A slideshow composition method, wherein a plurality of images, music data, and transition control parameters are acquired. The music data is then analyzed to acquire feature indices of the music data. An image duration range is determined based on the feature indices and the transition control parameters. A slideshow is composed based on the images, the feature indices and the transition control parameters, such that at least one of the images is displayed for an image duration limited to the image duration range when the slideshow is played.

### BACKGROUND OF THE INVENTION

1. Field of the Invention

The present invention relates to synchronization of music with images, and in particular to a slideshow composition method wherein slides thereof advance according to variations in background, music and adjustable transition control parameters.

2. Description of the Related Art

U.S. Pat. No. 6,639,649 discloses a method of playing a sequence of stored still images according to analysis of predominant recurring audio features. The disclosed method enables a user to simultaneously listen to a piece of music and watch still images which change in reaction to the predominant recurring audio features.

The disclosed method, however, does not provide means for adjusting desired image transition frequency or adding transition effects. Thus, in the conventional method, images transition according to variations in background music but transition parameters cannot be adjusted based on preference.

Hence, there is a need for a new slideshow composition method with adjustable image transition parameters.

### SUMMARY OF THE INVENTION

Accordingly, an object of the invention is to provide a slideshow composition method with adjustable image transition parameters.

In order to achieve the above object, the invention provides a slideshow composition method. First, a plurality of images, music data, and transition control parameters are acquired. Next, the music data is analyzed to acquire feature indices thereof. An image duration range is determined based on the feature indices and the transition control parameters. A slideshow is then composed based on the images, the feature indices and the transition control parameters, such that at least one of the images is displayed for an image duration limited to the image duration range when the slideshow is played.

In addition, the slideshow composition method of the invention can be implemented by a computer program recorded in a storage medium such as a memory or a memory device. The computer application, when loaded into a computer, directs the computer to execute the slideshow composition method of the invention.

### DESCRIPTION OF THE DRAWINGS

The present invention can be more fully understood by reading the subsequent detailed description and examples with references made to the accompanying drawings, wherein:

FIG. 1 is a block diagram of the configuration of a computing device 10 of the present invention;

FIG. 2 is a flowchart of the slideshow composition method of the present invention;

FIG. 3 is a schematic diagram of the image duration determination process;

FIG. 4 is a flowchart of transition point determination steps;

FIG. 5 is a schematic diagram of image duration D_{IM} and transition duration D_{TX};

FIG. 6 is a block diagram of the configuration of a slideshow composition system of the invention; and

FIG. 7 is a schematic diagram of a storage medium of the invention.

### DETAILED DESCRIPTION OF THE INVENTION

The invention provides a slideshow composition method wherein image transitions in a slideshow occur in accordance with audio features and parameter adjustment.

The slideshow composition method of the invention can be implemented in a computing device, such as a personal computer (PC), digital still camera or personal digital assistant (PDA).

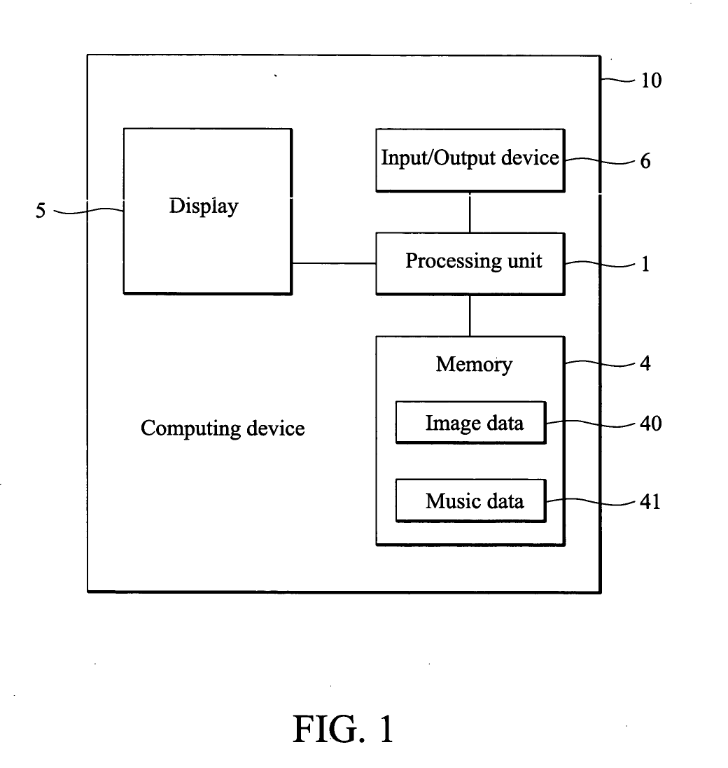

FIG. 1 is a block diagram of the configuration of a computing device 10 of the present invention. The computing device comprises a processing unit 1, memory 4, display 5 and input/output unit 6. Processing unit 1 couples memory 4, display 5 and input/output unit 6.

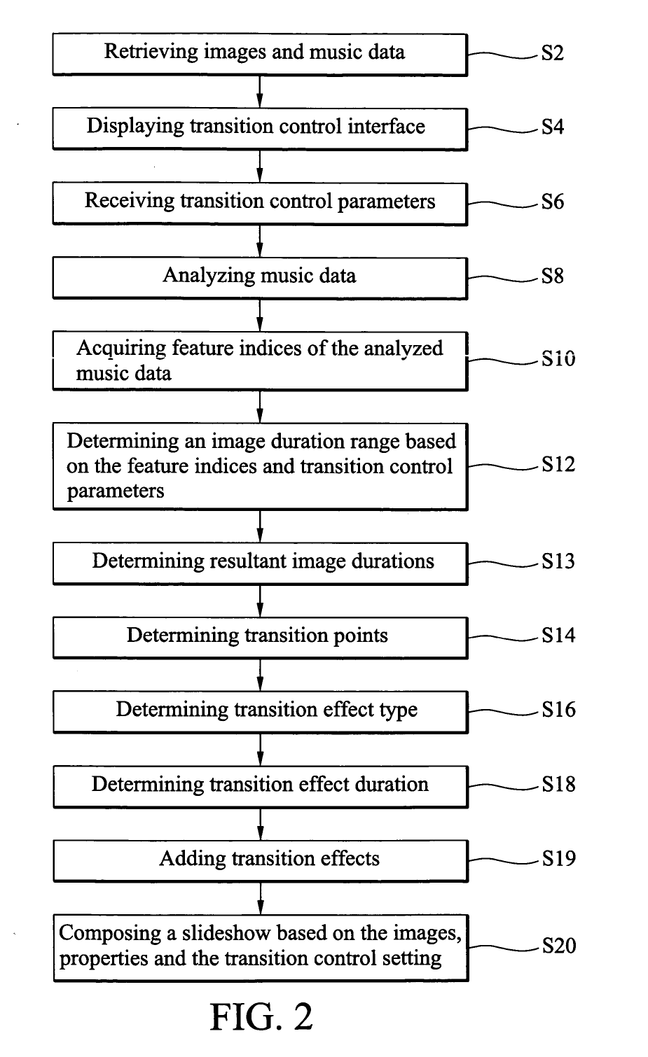

FIG. 2 is a flowchart of the slideshow composition method of the invention. The order of steps in the following description is provided as an example but is not intended to limit the invention.

Processing unit 1 retrieves music data 41 and image data 40 comprising a plurality of images (step S2). music data 41 and image data 40 may be stored in memory 4 in advance or input directly through input/output unit 6.

Processing unit 1 displays the transition control interface on display 5 (step S4) for input of transition control parameters. In the invention, transition control parameters comprise transition frequency, transition effect and transition speed. It is noted that the above-mentioned transition control parameters are not intended to limit the invention.

Transition control parameters are input and received by processing unit 1 (step S6).

Processing unit 1 analyzes the music data 41 (step S8) and acquires feature indices thereof (step S10). The feature indices comprise tempo, beat onset and micro-change indices. Tempo, which can be measured in BPM (beats per minute), relates to the speed of music data 41. Beat onset indices indicate the timing and strength characteristics of a specific instrument, such as drums or a bass. Micro-change indices indicate locally predominant changes in music data 41, comprising volume or pattern changes. Micro-change indices track volume fluctuations or the appearance of instruments, such as cymbals. It is noted that the feature indices described above are not intended to limit the invention.

Next, processing unit 1 determines an image duration range based on the acquired feature indices and transition control parameters (step S12). Image duration is the length of time for which an image is displayed. In the invention, still images transition more frequently with faster tempo, and less frequently with slower tempo. In other words, image duration is longer when the tempo value is lower and image duration is shorter when the tempo value is higher. In addition, the faster the transition frequency, the shorter is the average image duration, and the slower the transition frequency, the longer the average image duration. In the invention, the relationship of image duration, tempo and transition frequency is expressed as follows:

$$E ( {D}_{IM} ) = \frac{1}{{T}_{F} \times {T}_{M}} \times {C}_{T} , \qquad ( 1 )$$

wherein E(D_{IM}) is an expected value of image duration, T_{M} is tempo value, T_{F} is transition frequency, and C_{T} is a constant which is adjustable and related to tempo. For example, C_{T} may be set as 4 when the background music is in 4/4 time.

Processing unit 1 determines an image duration range based on the expected image duration value E(D_{IM}). The determined image duration range limits the displayed duration of individual images. The image duration range from a lower limit MIN(D_{IM}) to an upper limit MAX(D_{IM}) can be expressed as follows:
MIN(D_{IM})≦D_{IM}≦MAX(D_{IM}) (2)

D_{IM} is resultant image duration, the maximum and minimum probable values of which are MAX(D_{IM}) and MIN(D_{IM}) respectively. MAX(D_{IM}) and MIN(D_{IM}) can be derived by the following equations:
MAX(D_{IM})=E(D_{IM})×(1+V), (3)
MIN(D_{IM})=E(D_{IM})×(1−V) (4)
wherein V is another constant that sets the variance of image duration.

Processing unit 1 determines resultant image duration (step S13) and transition points (step S14) based on the image duration range.

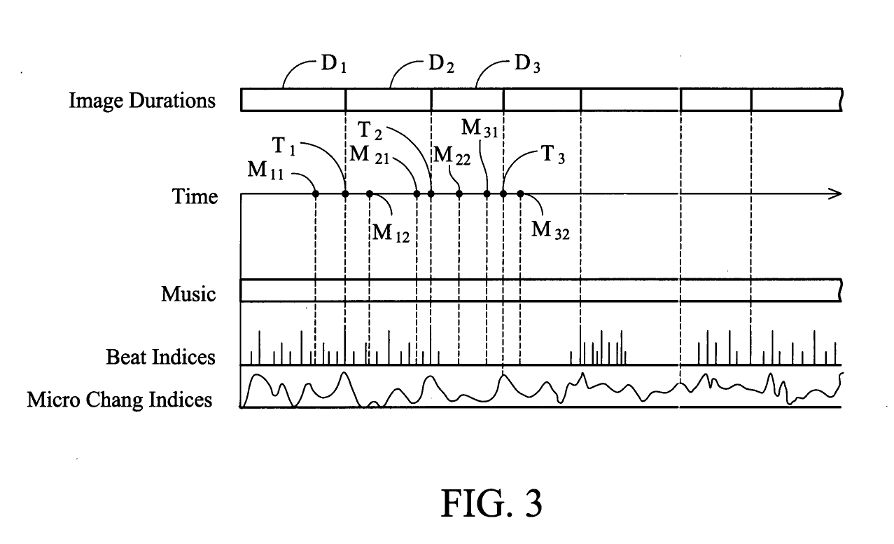

FIG. 3 is a schematic diagram of the image duration determination process. FIG. 3 shows four types of synchronization data, comprising image duration, music data 41, beat onset indices and micro-change indices. The beat onset indices and the micro-change indices are derived from the music data.

The image duration is limited by the image duration range and determined based on music data 41. In FIG. 3, D₁ represents the first image duration, and T₁ represents the end point of image duration D₁ on the timeline.

A transition point is the timing demarcating two adjacent image display periods, such as a beginning or end point of an image display period or a transition effect. In the invention, a transition point represents an end point of an image display period.

The range M₁₁ to M₁₂ in FIG. 3 represents a period wherein the method locates an end point of image duration D₁ and transition to duration D₂. In the invention, because image duration D₁ begins at zero on the timeline and is limited to within the image duration range, the values of M₁₁ and M₁₂ are MIN(D_{IM}) and MAX(D_{IM}) respectively.

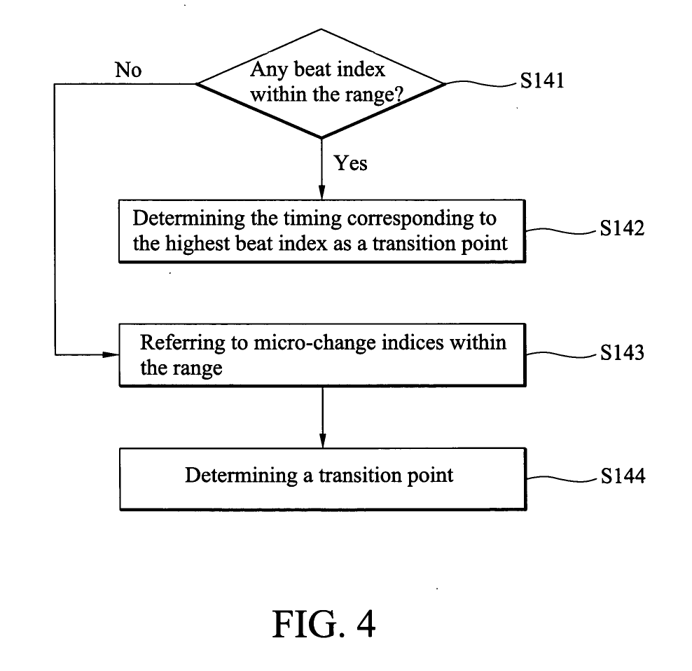

FIG. 4 is a flowchart of the transition point determination process. Processing unit 1 first determines a transition point based on at least the beat onset or micro-change indices. In the invention, processing unit 1 searches for beat onset indices during the end-point locating period (step S141). If any beat onset index exists in the end-point locating period, processing unit 1 determines the timing corresponding to the highest beat onset index as a transition point within the period (step S142).

If no beat onset index exists in the end-point locating period, processing unit 1 refers to micro-change indices within the period (step S143) and determines a transition point within the period based on micro-change indices (step S144). Processing unit 1 determines all transition points by the method described above. It is noted, however, that transition points can be determined by other methods. For example, a transition point may be determined based on one beat onset or a weighted summation of beat onset indices and micro-change indices.

For example, within the end-point locating period of image duration D₁, the timing T₁ corresponding to highest beat onset index is determined as a transition point. The timing T₂ corresponding to highest beat onset index is determined as a transition point during the end-point locating period of image duration D₂, ranging from M₂₁ to M₂₂. The timing T₃ corresponding to the highest micro-change index is determined as a transition point, because no beat onset index exists within the end-point locating period of image duration D₃, ranging from M₃₁ to M₃₂.

In the invention, the values of M₂₁ and M₂₂ are T₁+MIN(D_{IM}) and T₁+MAX(D_{IM}) respectively. The values of M₃₁ and M₃₂ are T₂+MIN(D_{IM}) and T₂+MAX(D_{IM}) respectively. In other words, image duration is limited between E(D_{IM})×(1−V) and E(D_{IM})×(1+V).

In the invention, the image duration range limits length of time an image is displayed. Other limitations, however, can be adopted.

When a transition point is determined, which is an end point, an image display period ending at the transition point is also defined.

In the invention, the constant V is adjustable. The image duration range corresponds to the value of V. Hence, the probability of locating preferred transition points is greater when the value of V is larger. The lower the value of V, the shorter the image duration range is. Hence, the variation between individual image durations is smaller.

In the invention, slide shows may comprise transition effects. Processing unit 1 determines the type and duration of transition effects (step S16 and S18). The acquired transition control parameters comprise transition speed and transition type for determining speed and type of transition effects respectively. Transition effects may comprise, for example, cross-fade effects. Transition effect duration is in inverse proportion with the tempo and speed of the transition effect. In the invention, transition effect duration can be represented as follows:

$${D}_{TX} = \frac{1}{{T}_{S} \times {T}_{M}} \times {C}_{T} , \qquad ( 5 )$$

wherein D_{TX} is transition effect duration, and T_{S} is the speed of the transition effect according to selected transition control parameters. Processing unit 1 determines transition effect duration D_{TX} based on the transition speed T_{S}, the tempo T_{M} and the constant C_{T}. When 1/T_{S} equals zero, no transition effects is present. T_{S} limits all transition effects in a slideshow. This arrangement, however, is not intended to limit the invention. Transition speed and transition effect type are adjustable. Processing unit 1 adds transition effects for the images according to the determined transition effect type and duration (step S19).

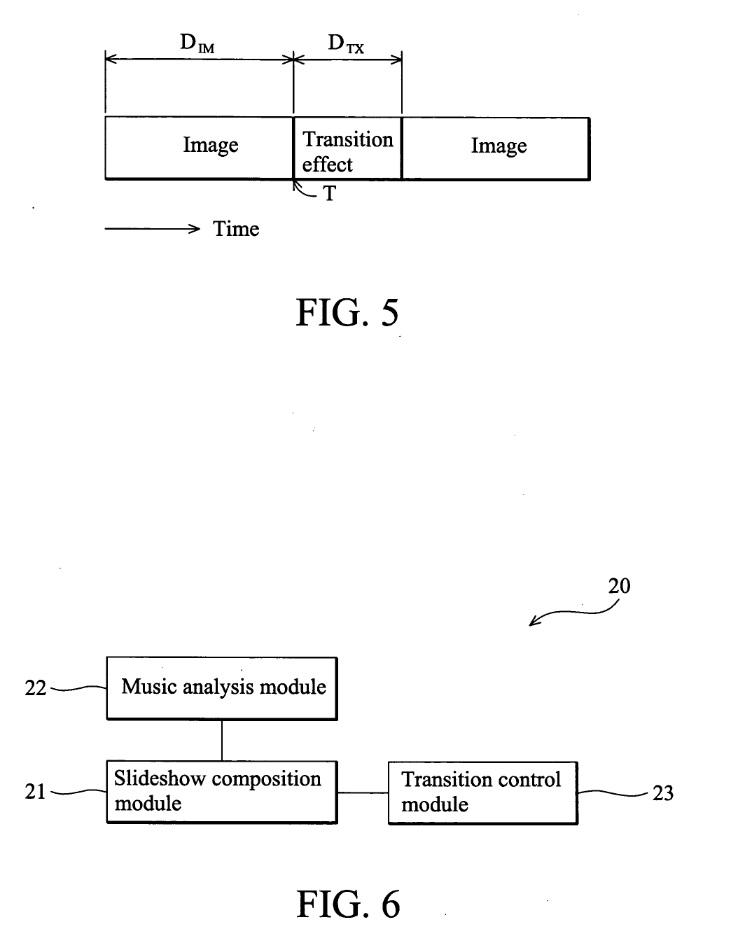

FIG. 5 is a schematic diagram of image duration D_{IM} and transition duration D_{TX}. A transition point T is the beginning of a transition effect period as shown in FIG. 5. The arrangement, however, is not intended to limit the invention. A transition effect period can be located anywhere near a transition point.

Processing unit 1 composes a slideshow based on the acquired images, feature indices and transition control parameters using the method described above (step S20) When the composed slideshow plays, at least one of the images 40 is displayed during an image display period, duration of which is limited to the image duration range. The images of the composed slideshow change according to the feature indices of music data 41 and selected transition control parameters.

FIG. 6 is a block diagram of the configuration of a slideshow composition system 20 of the present invention. This slideshow composition system 20 implementing the slideshow composition method of the invention comprises a music analysis module 21, a transition control module 22 and a slideshow composition module 23. Slideshow composition module 23 comprises music analysis module 21 coupled with transition control module 22.

Music analysis module 21 analyzes music data and acquires feature indices thereof. Transition control module 22 acquires transition control parameters. Slideshow composition module 23 acquires images and composes a slideshow based on acquired images, music data and transition control parameters.

A storage medium storing a computer program for implementing the slideshow composition method of the invention is also provided.

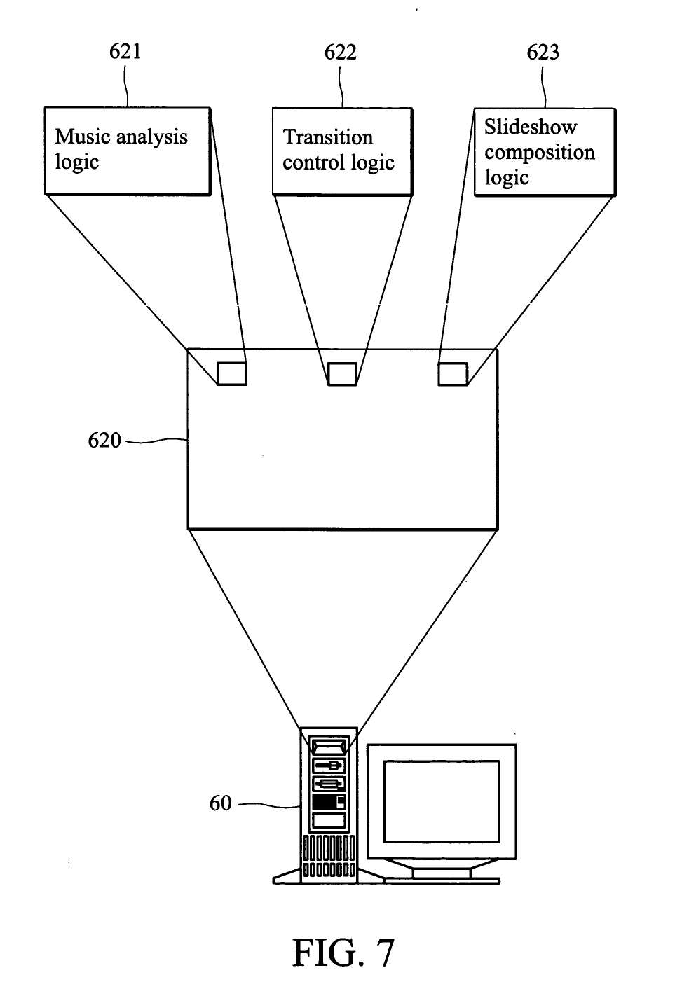

FIG. 7 is a schematic diagram of the storage medium of the invention. Storage medium 60 stores a computer program 620 for implementing the slideshow composition method of the invention. The computer program 620 comprises a music analysis logic 621, a transition control logic 622 and a slideshow composition logic 623.

Music analysis logic 621 analyzes music data and acquires feature indices thereof. Transition control logic 622 acquires transition control parameters. Slideshow composition logic 623 acquires images and composes a slideshow based on acquired images, music data and transition control parameters.

Thus, the slideshow composition method of the invention changes images according to audio features and parameter adjustment.

While the invention has been described by way of example and in terms of the preferred embodiments, it is to be understood that the invention is not limited to the disclosed embodiments. To the contrary, it is intended to cover various modifications and similar arrangements (as would be apparent to those skilled in the art). Therefore, the scope of the appended claims should be accorded the broadest interpretation so as to encompass all such modifications and similar arrangements.

1. A slideshow composition method, comprising the steps of:
acquiring a plurality of images, music data, and transition control parameters;
analyzing the music data to acquire feature indices of the music data;
determining an image duration range based on the feature indices and the transition control parameters; and
composing a slideshow comprising the images, the feature indices and the transition control parameters, wherein at least one of the images is displayed for an image duration limited to the image duration range.

2. The method as claimed in claim 1, wherein the feature indices include tempo, and the image duration corresponds to tempo speed.

3. The method as claimed in claim 1, wherein the transition control parameters comprise transition frequency, and the image duration corresponds to the transition frequency.

4. The method as claimed in claim 1, wherein the feature indices comprise tempo T_{M}, transition control parameters comprise transition frequency T_{F}, and the expected value E(D_{IM}) of the image duration is derived by
$$E ( {D}_{IM} ) = \frac{1}{{T}_{F} \times {T}_{M}} \times {C}_{T} ,$$
wherein C_{T} comprises a constant; the image duration ranges from MIN(D_{IM}) to MAX(D_{IM}), wherein MIN(D_{IM}) and MAX(D_{IM}) are derived respectively by
MAX(D_{IM})=E(D_{IM})×(1+V) and
MIN(D_{IM})=E(D_{IM})×(1−V),
wherein V comprises another constant.

5. The method as claimed in claim 1, wherein the feature indices further comprise at least beat onset or micro-change indices.

6. The method as claimed in claim 5, wherein a transition point demarcates two adjacent periods of image duration, and the method further comprises the step of determining a transition point based on at least the beat onset or the micro-change indices.

7. The method as claimed in claim 6, wherein the method further comprises the step of searching the timeline for a transition point corresponding to the highest beat onset index within one period of beat onset indices limited to the image duration range.

8. The method as claimed in claim 7, wherein the method further comprises the step of searching for a transition point based on the micro-change indices within the period thereof limited to the image duration range when no beat onset index exists in the period.

9. The method as claimed in claim 6, wherein the slideshow further comprises a transition effect initiated by the transition point.

10. The method as claimed in claim 1, wherein the slideshow further comprises a transition effect, the transition control parameters further comprise at least the type or speed of the transition effect, and the method further comprises the step of adding the transition effect based on at least the type or speed of the transition effect.

11. The method as claimed in claim 10, wherein the feature indices further comprise tempo, and the duration of the transition effect is in inverse proportion with the tempo and the speed of the transition effect.

12. A machine-readable storage medium storing a computer program which, when executed, directs a computer to perform a slideshow composition method comprising the steps of:
retrieving a plurality of images, music data, and transition control parameters;
analyzing the music data to acquire feature indices thereof;
determining an image duration range based on the feature indices and the transition control parameters; and
composing a slideshow comprising the images, the feature indices and the transition control parameters, wherein at least one of the images is displayed for an image duration limited to the image duration range when the slideshow is played.

13. The machine-readable storage medium as claimed in claim 12, wherein the feature indices comprise tempo, and the image duration corresponds to tempo speed.

14. The machine-readable storage medium as claimed in claim 12, wherein the transition control parameters comprise transition frequency, and the image duration corresponds to the transition frequency.

15. The machine-readable storage medium as claimed in claim 12, wherein the feature indices comprise tempo T_{M}, transition control parameters comprise transition frequency T_{F}, and the expected value E(D_{IM}) of the image duration is derived by
$$E ( {D}_{IM} ) = \frac{1}{{T}_{F} \times {T}_{M}} \times {C}_{T} ,$$
wherein C_{T} comprises a constant; the image duration range ranges from MIN(D_{IM}) to MAX(D_{IM}), wherein MIN(D_{IM}) and MAX(D_{IM}) are derived respectively by
MAX(D_{IM})=E(D_{IM})×(1+V), and
MIN(D_{IM})=E(D_{IM})×(1−V),
wherein V is another constant.

16. The machine-readable storage medium as claimed in claim 12, wherein the feature indices further comprise at least beat onset or micro-change indices.

17. The machine-readable storage medium as claimed in claim 16, wherein a transition point demarcates two adjacent periods of image duration, and the method further comprises the step of determining a transition point based on at least the beat onset or the micro-change indices.

18. The machine-readable storage medium as claimed in claim 17, wherein the method further comprises the step of searching the timeline for a transition point corresponding to the highest beat onset index within one period of beat onset indices limited to the image duration range.

19. The machine-readable storage medium as claimed in claim 18, wherein the method further comprises the step of searching for a transition point based on the micro-change indices within the period thereof limited to the image duration range when no beat onset index exists in the period.

20. The machine-readable storage medium as claimed in claim 17, wherein the slideshow further comprises a transition effect initiated by the transition point.

21. The machine-readable storage medium as claimed in claim 12, wherein the slideshow further comprises a transition effect, the transition control parameters further comprise at least the type or speed of the transition effect, and the method further comprises the step of adding the transition effect based on at least the type or speed of the transition effect.

22. The machine-readable storage medium as claimed in claim 21, wherein the feature indices further comprise tempo, and the duration of the transition effect is in inverse proportion with the tempo and the speed of the transition effect.
